(19) United States
(12) Patent Application Publication
(10) Pub. No.: US 2018/0139419 A1
(43) Pub. Date: May 17, 2018

(54) VIDEO PROJECTOR

(71) Applicant: Telebrands Corp., Fairfield, NJ (US)

(72) Inventors: Ajit KHUBANI, Saddle River, NJ (US); Lou LENTINE, Chattanooga, TN (US)

(21) Appl. No.: 15/809,881

(22) Filed: Nov. 10, 2017

Related U.S. Application Data
(60) Provisional application No. 62/420,808, filed on Nov. 11, 2016.
(60) Provisional application No. 62/448,090, filed on Jan. 19, 2017.

(51) Int. Cl. H04N 9/31

(52) U.S. Cl. CPC H04N 9/3141

(57) ABSTRACT

A window projector including a memory having a first media and a second media stored thereon, a display assembly configured to display at least one of the first media and the second media, the first media associated with a first characteristic and the second media associated with a second characteristic, and a first dedicated switch dedicated for displaying the first media and a second dedicated switch dedicated for displaying the second media. The first dedicated switch being configured such that an actuation of the first dedicated switch causes the display assembly to display the first media from the memory and the second dedicated switch being configured such that an actuation of the second dedicated switch causes the display assembly to display the second media from the memory.

### CROSS-REFERENCE TO PRIOR APPLICATIONS

This application claims priority to U.S. Provisional Application Ser. No. 62/420,808, filed on Nov. 11, 2016, and U.S. Provisional Application Ser. No. 62/448,090, filed on Jan. 19, 2017. Both applications are hereby incorporated by reference herein in their entireties.

### BACKGROUND

During various holidays, many people take great efforts to decorate their homes and properties. Holiday decorations can create festive scenes and environments for celebrating the holidays. Many people decorate with lights, figures, plants, flowers, vegetation, etc. Despite how enjoyable holiday decorations can be, decorating for the holidays can often be difficult and time-consuming. Further, decorating certain features of a home, such as windows, can often be challenging.

### SUMMARY

Embodiments of the present invention can provide a window projector including a memory having a first media and a second media stored thereon, a display assembly configured to display at least one of the first media and the second media, the first media associated with a first characteristic and the second media associated with a second characteristic and a first dedicated switch dedicated for displaying the first media and a second dedicated switch dedicated for displaying the second media. The first dedicated switch can be configured such that an actuation of the first dedicated switch may cause the display assembly to display the first media from the memory and the second dedicated switch can be configured such that an actuation of the second dedicated switch may cause the display assembly to display the second media from the memory.

According to certain embodiments, the first characteristic and the second characteristic can be different. For example, the first and second characteristics can each include a holiday. Further, the display assembly can include at least one optical element.

According to certain embodiments, the first media can include a plurality of media, and successive actuations of the first dedicated switch can cycle through the plurality of media. Further, the second media can include a plurality of media, and successive actuations of the second dedicated switch can cycle through the plurality of media. According to certain embodiments, the first media can include a landscape media version and a portrait media version. The window projector can further include at least one dedicated orientation switch to change an orientation of the first media, the dedicated orientation switch may be configured to provide selective orientation control between the landscape media version and the portrait media version of the first media.

Another embodiment of the present invention can provide a window projector including a memory having a first media and a second media stored thereon, the first media having a first content configured to be displayed in a landscape orientation and the second media having the first content configured to be displayed in a portrait orientation, a display assembly can be configured to display at least one of the first media and the second media, and a switch including a first setting and second setting. Further, the first setting can correspond to the projector projecting the first media and the second setting can correspond to the projector projecting the second media.

Further, the window projector can include a first dedicated switch dedicated to displaying the first content. The first dedicated switch can be configured such that an actuation of the first dedicated switch can cause the display assembly to display the first content from the memory. The memory can include a third media and a fourth media stored thereon. The third media can include a second content configured to be displayed in a landscape orientation and the fourth media can include the second content configured to be displayed in a portrait orientation. The window projector can further include a second dedicated switch dedicated to displaying the second content. The second dedicated switch can be configured such that an actuation of the second dedicated switch can cause the display assembly to display the second content from the memory. The first and second content can include an associated characteristic, including a holiday.

According to certain aspects, the switch can include a third setting corresponding to the projector being in an OFF condition. The switch can include a three-way rocker switch.

Another embodiment of the present invention can provide a method of projecting content, the method including providing a memory having a first media and a second media stored thereon, providing a display assembly configured to display at least one of the first media and the second media, the first media associated with a first characteristic and the second media associated with a second characteristic and a first dedicated switch dedicated for displaying the first media and a second dedicated switch dedicated for displaying the second media. The first dedicated switch can be configured such that an actuation of the first dedicated switch may cause the display assembly to display the first media from the memory and the second dedicated switch can be configured such that an actuation of the second dedicated switch may cause the display assembly to display the second media from the memory. The method may further include projecting the first media upon actuation of the first dedicated switch.

According to certain aspects, the method may further include projecting the second media upon actuation of the second dedicated switch.

Yet another embodiment of the present invention can provide a method of projecting content in different orientations, the method including providing a memory having a first media and a second media stored thereon, the first media may include a first content configured to be displayed in a landscape orientation and the second media may include the first content configured to be displayed in a portrait orientation. The method may include providing a display assembly configured to display at least one of the first media and the second media. The method may further include providing a switch having a first setting and second setting, the first setting corresponding to the projector projecting the first media and the second setting corresponding to the projector projecting the second media. The method may further include projecting at least one of the first media and the second media upon actuation of the switch.

### BRIEF DESCRIPTION OF THE DRAWINGS

The features and advantages of the present invention can be more readily understood from the following detailed description with reference to the accompanying drawings, wherein:

FIG. 1 is a diagram of an exemplary window projection system according to one embodiment of the present invention;

FIG. 2 is a diagram of an exemplary projector according to one embodiment of the present invention;

FIG. 3 is a diagram of an exemplary projector according to one embodiment of the present invention;

FIG. 4 is a diagram of an exemplary projector according to one embodiment of the present invention; and

FIG. 5 is a diagram of an exemplary projector according to one embodiment of the present invention;

FIG. 6 is a diagram of an exemplary projector according to one embodiment of the present invention;

FIG. 7 is a diagram of an exemplary display assembly according to one embodiment of the present invention;

FIG. 8 is a diagram of an exemplary light assembly according to one embodiment of the present invention;

FIG. 9 is a diagram of an exemplary light assembly according to one embodiment of the present invention;

FIG. 10 is a diagram of an exemplary output assembly according to one embodiment of the present invention;

FIG. 11 is a flow diagram of an exemplary method of projecting content according to one embodiment of the present invention; and

FIG. 12 is a flow diagram of an exemplary method of projecting content according to one embodiment of the present invention.

### DETAILED DESCRIPTION

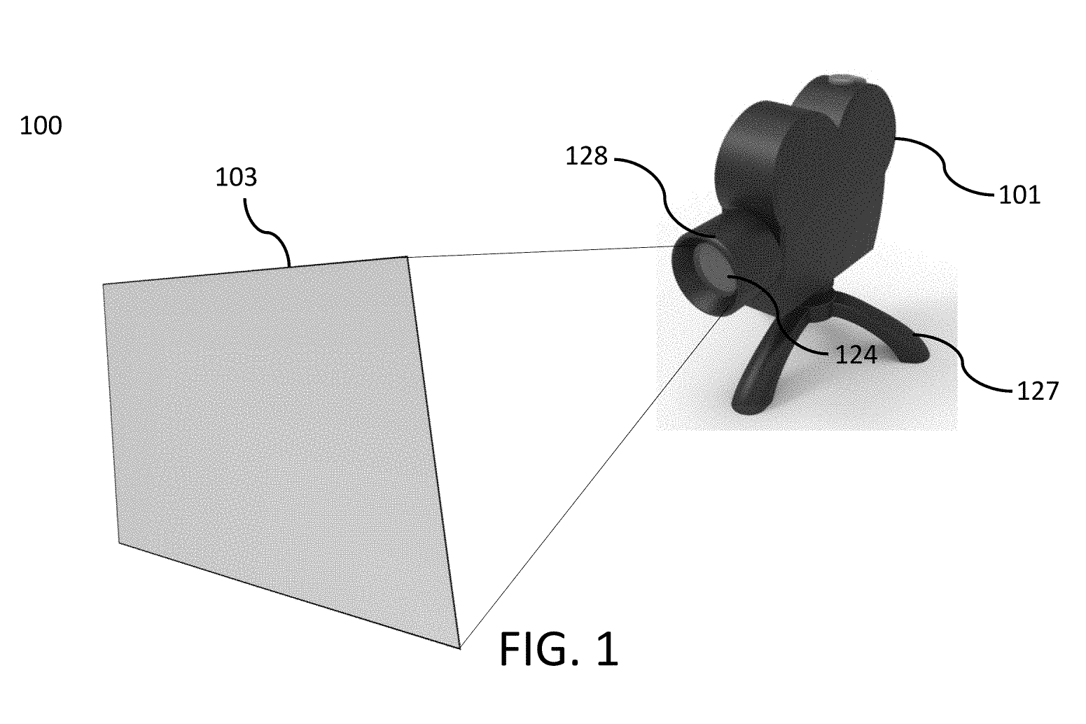

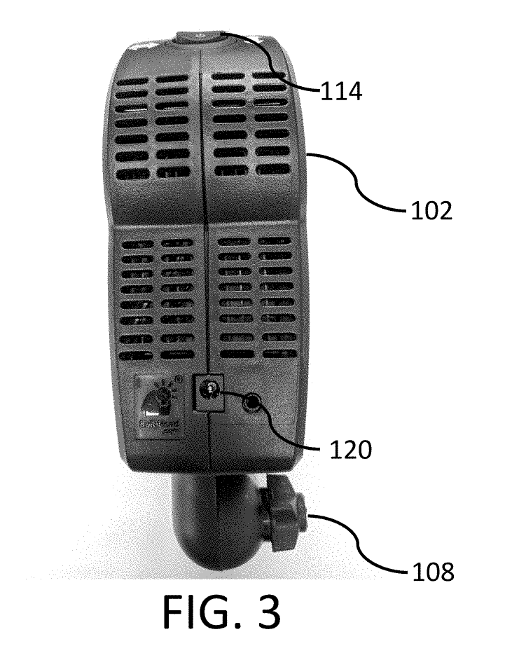

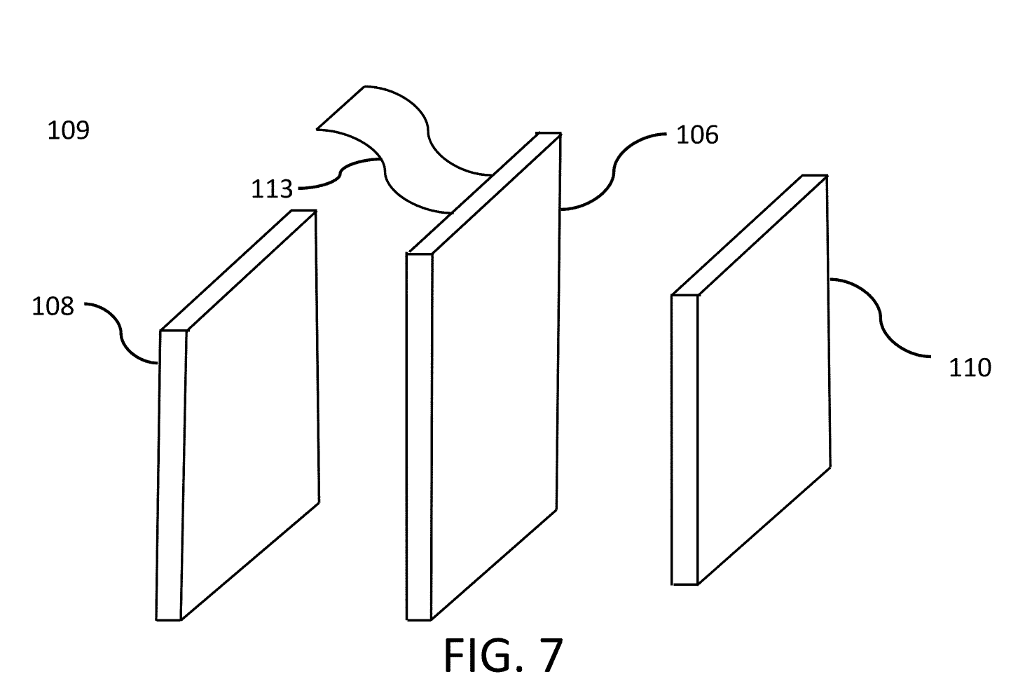

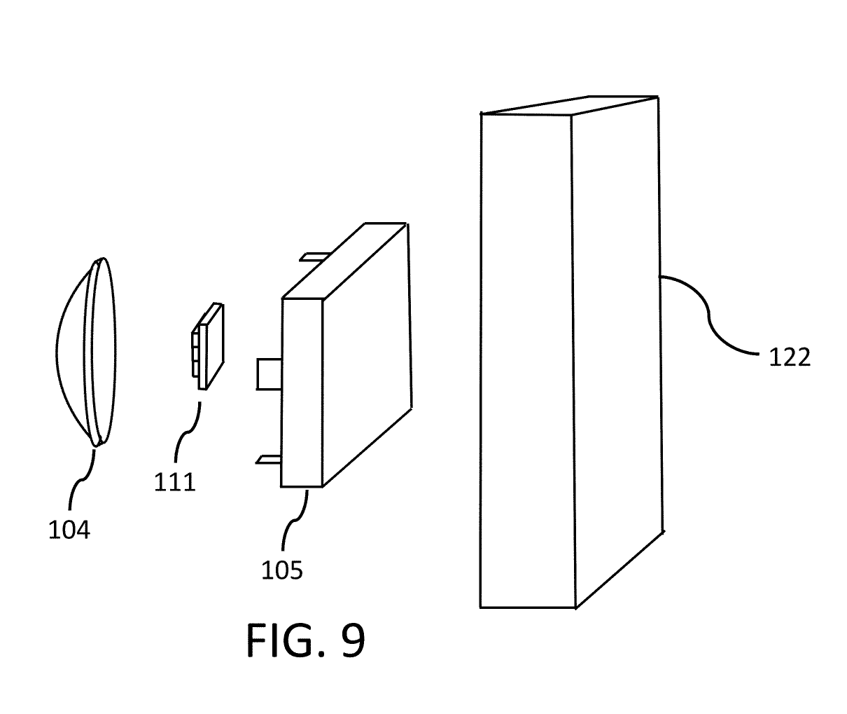

Exemplary embodiments of the present invention can provide a novel window projection system. An embodiment of the present invention can provide an exemplary window projection system 100 as shown in FIGS. 1-10. The exemplary window projection system 100 can facilitate simple decorating of a window. For example, the exemplary window projection system 100 can be set up inside a home to project images and/or videos onto a window so that the images, scenes, and/or videos/video clips projected by the projector onto the window can be seen from outside the home in the window. The images and/or videos projected onto the window can include any media a user desires to be shown to people outside the home to provide a decorative effect, such as images, patterns, and/or videos. Embodiments of the present invention can also provide an outdoor projection system that can project decorative images, shapes, patterns, scenes, and/or videos/video clips on an exterior surface. For example, the projected images, scenes, etc. can include ghosts, pumpkins/jack-o-lanterns, Santa Claus, Christmas trees, falling snow, shadows, silhouettes, movies, etc. projected onto an exterior wall of a home.

According to embodiments of the present invention, FIG. 1 shows an exemplary window projection system 100, which can include projection screen 103 and projector 101. In operation, exemplary window projection system 100 can be disposed inside a structure such as a home such that projection screen 103 is positioned on an interior side of a window, and when the media is projected onto projection screen 103 by projector 101, the media being projected can be seen from the outside of the structure in the window.

Projection screen 103 can include a surface such as a sheet that is at least partially transparent. For example, projection screen 103 can be, for example, a white, plastic, nylon, or cloth sheet. Projection screen 103 can be a rear projection screen that preferably includes a material that will allow the image and/or videos to be clearly displayed on the projection side while also allowing the projected image and/or videos to be seen from the opposite side, i.e., the viewing side of projection screen 103. Projection screen 103 may include a projection side, onto which the media is projected, and a viewing side, on which the projected media can be viewed. In one embodiment of the present invention, projection side of projection screen 103 may be facing projector 101, while viewing side may be disposed on the opposite side of projection screen 103, i.e., facing opposite projector 101. According to certain embodiments, both sides of projection screen 103 may act as either the projection side and/or the viewing side. In another embodiment of the present invention, projection side and viewing side of projector screen 103 may be the same side. Accordingly, projection screen 103 can be positioned in a window (e.g., on the interior side of the window) and projector 101 can project media, such as images or videos on the projection side of projection screen 103. The media projected onto the projection side of projection screen 103 by projector 101 can be seen on the viewing side of projection screen 103. This can allow for the projected media to be seen from outside the window in which projection screen 103 is disposed while projector 101 is projecting media onto projection screen 103 from an interior side of the window.

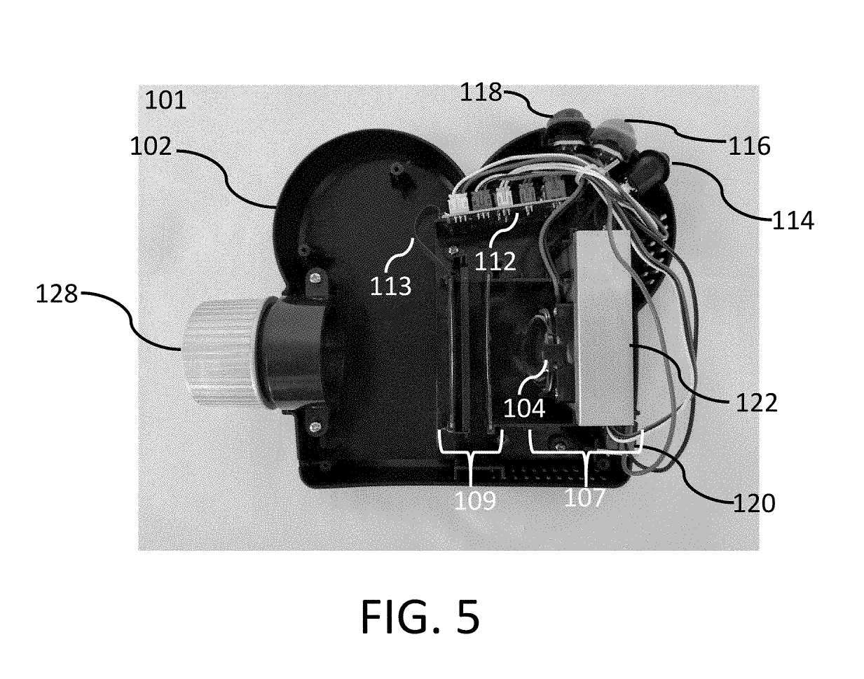

As shown in FIG. 5, projector 101 may include housing 102, light assembly 107, display assembly 109, switches 114, 116, and 118, printed circuit board (PCB) 112, output assembly 128, power port 120, and stand 106. Light assembly 107, display assembly 109, and output assembly 128 may be disposed within housing 102 to produce and project media from projector 101. For example, light assembly 107 and display assembly 109 can be controlled via switches 114, 116, and 118 and PCB 112 to project the media displayed by display assembly 109 via output assembly 128. Display assembly 109 can produce an image of the media to be projected, and light assembly 107 can generate light to project the image, which can be focused by output assembly 128, onto a surface. Power port 120 may be configured to receive power from an external power supply to provide power to switches 114, 116, and 118, PCB 112, light assembly 107, and display assembly 109. Although projector 101 is shown including power port 120 to receive external power, projector 101 may be powered by any power source, such as a battery, a wireless charging device, a charger pack, or any other means capable of providing power to projector 101.

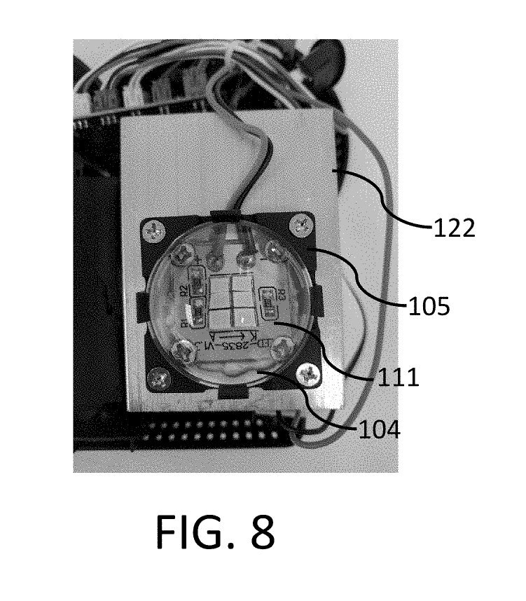

As shown in FIGS. 5-6, 8, and 9, light assembly 107 may be disposed within housing 102 and may include heat sink 122, lens 104, light source 111, and lens mount 105. As shown in FIGS. 5-6, 8, and 9, lens 104 may be coupled to heat sink 122 via lens mount 105. According to embodiments of the present invention, lens mount 105 may be coupled to heat sink 122 via screws. However, lens mount 105 may be coupled to heat sink 122 by any means such as adhesives, magnets, welding, or any other means of coupling lens mount 105 to heat sink 122. Light source 111 may be disposed within lens mount 105 and may be further coupled to heat sink 122 to facilitate dissipation of heat generated by light source 111. In one embodiment of the present invention, light source 111 may be coupled to heat sink 122 via screws, however, light source 111 may be coupled to heat sink 122 by any other means such as adhesives, magnets, welding, etc. As shown in FIG. 8, light source 111 may include one or more light-emitting-diode (LED), such as a chip-on board (COB) LED. However, light source 111 may be any type of element capable of generating the desired light for sufficiently projecting the media on projection screen 103. For example, light source 111 may be a laser, an incandescent light bulb, a high-intensity discharge bulb, a fluorescent bulb, a halogen bulb, etc. In one embodiment of the present invention, lens 104 may be coupled to lens mount 105 via snap fasteners. However, lens 104 may be coupled to lens mount 105 by other means such as adhesives, screws, nails, or any other means of coupling lens 104 to lens mount 105. As shown in FIGS. 5,6, and 8, light source 111 can be electrically coupled to PCB 112, and according to one embodiment of the present invention, the light generated by light source 111 may exit lens 104 and travel through display assembly 109 before exiting projector 101 via output assembly 128. Lens 104 may be used to manipulate the light generated by light source 111 prior to the light passing through display assembly 109.

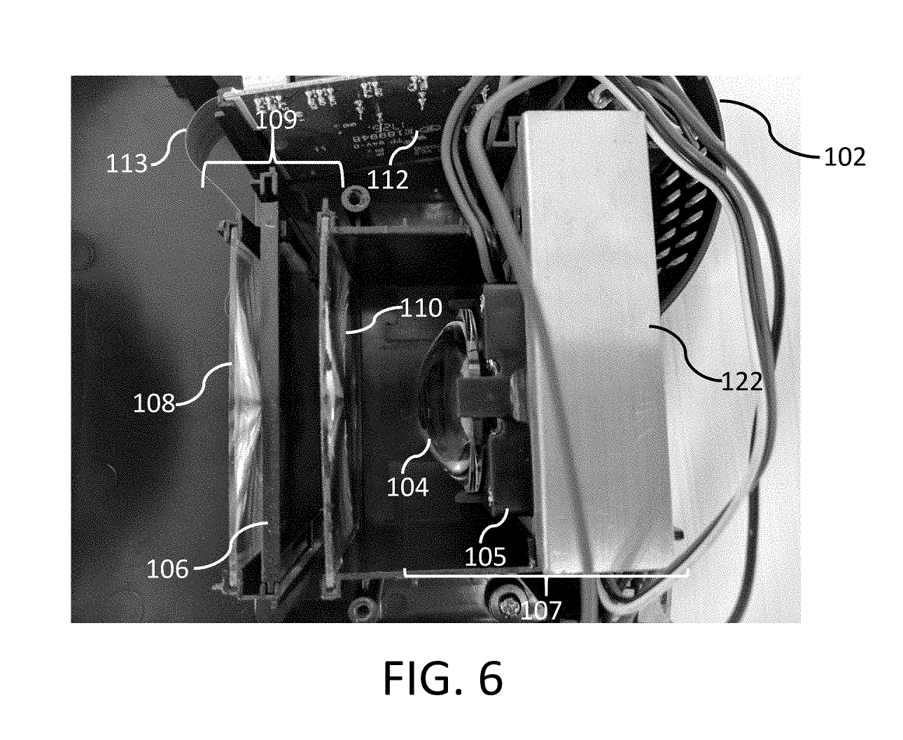

As shown in FIGS. 5-7, projector 101 may include display assembly 109. Display assembly 109 may include optical elements 108, 110, and display 106. As shown in FIGS. 5 and 6, display 106 can display the media to be projected, and optical elements 108 and 110 can condition the light generated by light assembly 107. For example, PCB 112 can include a memory that can store various media, such as images, videos, etc. that is to be projected by projector 101. The media stored in the memory on PCB 112 can be displayed on display 106, which can be projected by projector 101. Display 106 can display the media to be projected and the light generated by light source 111 can project an image of the media produced on display 106 on a surface, such as projection screen 103. In practice, light exiting light assembly 107 via lens 104 may pass through optical element 110 prior to passing through display 106, and may pass through optical element 108 after passing through display 106. Optical element 110 may include any optical element to suitably condition the light, such as a beam expander, collimating lens, diffraction grating, attenuator, Fresnel lens, or any other type of element capable of conditioning the light exiting light assembly 107. After passing through optical element 110, the conditioned light may pass through display 106, and after passing through display 106, the light can pass through optical element 108 prior to exiting projector 101 via output assembly 128. Optical element 108 may include any optical element to suitably condition the light, such as a beam expander, collimating lens, diffraction grating, attenuator, Fresnel lens, or any other type of element capable of conditioning the light exiting display 106. Although FIGS. 5 and 6 show display 106 being a liquid crystal display (LCD), display 106 may include any other type of display capable of displaying media to be projected by projector 101. Further, although FIGS. 5-7 shows display assembly 109 having two optical elements 108, 110, display assembly 109 may have any number of optical elements such as one, three, four, etc. or zero optical elements.

In producing the media to be projected, display 106 may be electrically coupled to PCB 112. In one embodiment of the present invention, display 106 may be coupled to PCB 112 via connector 113. As shown in FIGS. 5 and 6, PCB 112 may be disposed within housing 102 and may include a memory or other storage medium to store the media that can be projected by projector 101. Alternatively, PCB 112 can include an adapter, slot, or other interface (e.g., USB, etc.) to receive an external storage medium (e.g., thumb drive, SD card, other memory card, external hard drive, etc.) on which media to projected can be stored, thereby allowing the user to select and change the media to be projected by projector 101. According to certain exemplary embodiments, PCB 112 can include various media, including videos, images, animations, pictures, movie clips, etc. stored in a memory, which can be displayed via display 106. PCB 112 can include one or more processors to display the media on display 106, and the media displayed on display 106 can be projected by projector 101 by the light produced by light assembly 107. In practice, light exiting light assembly 107 may enter display assembly 109, striking display 106. The light may then pass through display assembly 109, exit output assembly 128, and strike projection screen 103, displaying the media from display 106 onto projection screen 103. According to certain exemplary embodiments, projector 101 can include media specific for particular holidays (e.g., Christmas, Halloween, Thanksgiving, Easter, 4th of July, etc.). For example, projector 101 can include media such as ghosts, witches, pumpkins/jack-o-lanterns, cemeteries/tombstones, etc. for Halloween; Christmas trees, presents, Santa Claus, snowmen, snow falling, a burning fire, candy canes, etc. for Christmas, and other holiday specific media for other various holidays.

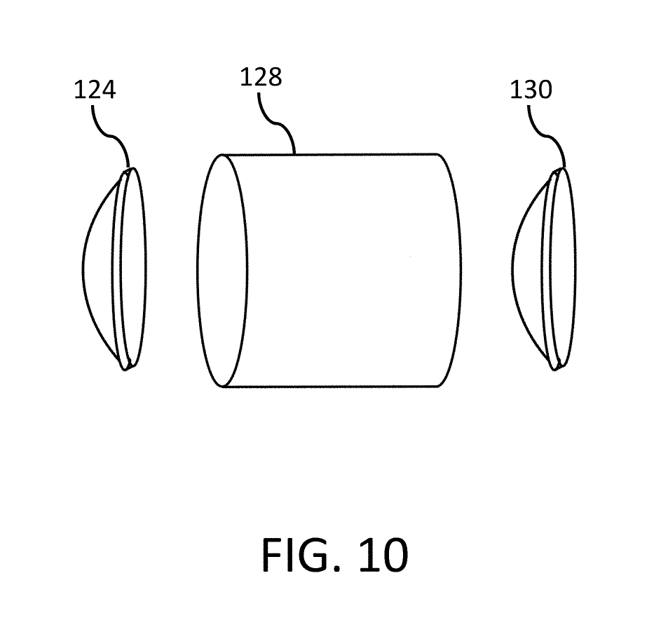

As shown in FIGS. 1 and 10, output assembly 128 may include output lenses 124 and 130. Although FIG. 10 shows output assembly 128 housing two output lenses 124 and 130, output assembly 128 may include any number of output lenses, such as one, three, four, five, or any number desired. Output lenses 124 and 130 may be disposed within output assembly 128, and output assembly 128 may be coupled to housing 102. In practice, light exiting display assembly 109 may pass through output lens 130 prior to exiting projector 101 via output assembly 128 and output lens 124. In one embodiment of the present invention, output assembly 128 may be adjustable to allow a user to adjust the focus of the media exiting projector 101 via output assembly 128. For example, output assembly 128 may include threads which can allow output assembly 128 to be linearly adjusted relative to housing 102 by rotating output assembly 128 relative to housing 102. In another example, output assembly 128 may be telescopically coupled to housing allowing linear adjustment relative to housing 102 of output assembly 128, without rotation of output assembly 128. In yet another example, output assembly 128 may include an automatic focus, where output assembly 128 includes electronic sensors to determine the optimal focus.

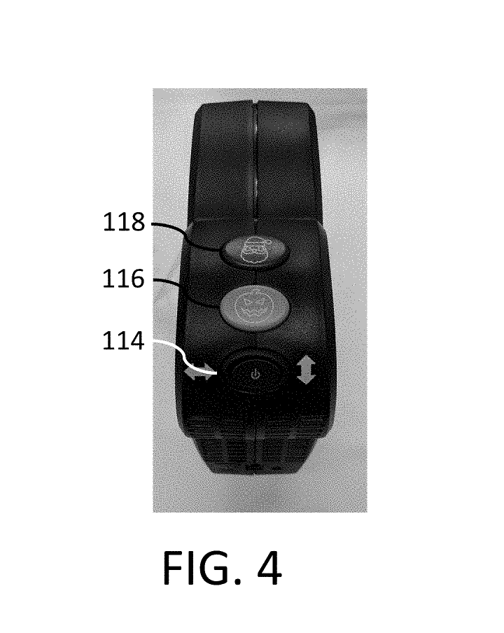

In one embodiment of the present invention, projector 101 can include simple one-switch operation. For example, projector 101 can include a single switch that a user can actuate to activate operation of projector 101. As shown in FIGS. 4 and 5, projector 101 can include switches 118 or 116, which can provide one-touch operation of projector 101. For example, actuating either switch 118 or 116 can activate projector 101 to project the media associated with the respective switch. Subsequent actuations of the same switch can sequentially cycle projector 101 through the various media associated with the respective switch stored in the memory of PCB 112, thereby allowing a user to select the desired media to be projected. When the user has scrolled through all the media associated with the respective switch with successive actuations of the switch, the subsequent actuation of the switch can turn projector 101 OFF. Alternatively, the switch can be depressed and held down, and projector 101 can sequentially scroll through the available media while the switch is being depressed, and a user can select a media by letting go of the switch when projector 101 has scrolled to the desired media.

According to certain exemplary embodiments, projector 101 can include power switch 114 to power projector 101 ON and OFF, and can include switches 116, 118 that can allow a user to sequentially scroll through the available media. For example, switches 116 and 118 can be dedicated switches, where each of switches 116 and 118 can specifically correspond to and/or be associated with specific media stored in the memory of projector 101. According to certain exemplary embodiments, each of switches 116 and 118 can specifically correspond to media sharing a certain characteristic (e.g., a holiday, a theme, etc.). For example, switch 116 can correspond to all Christmas-themed media stored in the memory of projector 101 and switch 118 can correspond to all Halloween-themed media stored in the memory of projector 101. Accordingly, sequential actuations of switch 116 can sequentially scroll through all Christmas-themed media and sequential actuations of switch 118 can sequentially scroll through all Halloween-themed media. In this manner, switches 116 and 118 may be dedicated to media having a specific characteristic (e.g., holiday). In this embodiment, the projector 101 would preferably have a corresponding number of dedicated switches for the number of holiday media stored in its memory (i.e., a dedicated switch for each holiday—e.g., 3 dedicated switches if projector 101 has media for 3 different holidays, 4 dedicated switches if projector 101 has media for 4 different holidays, etc.).

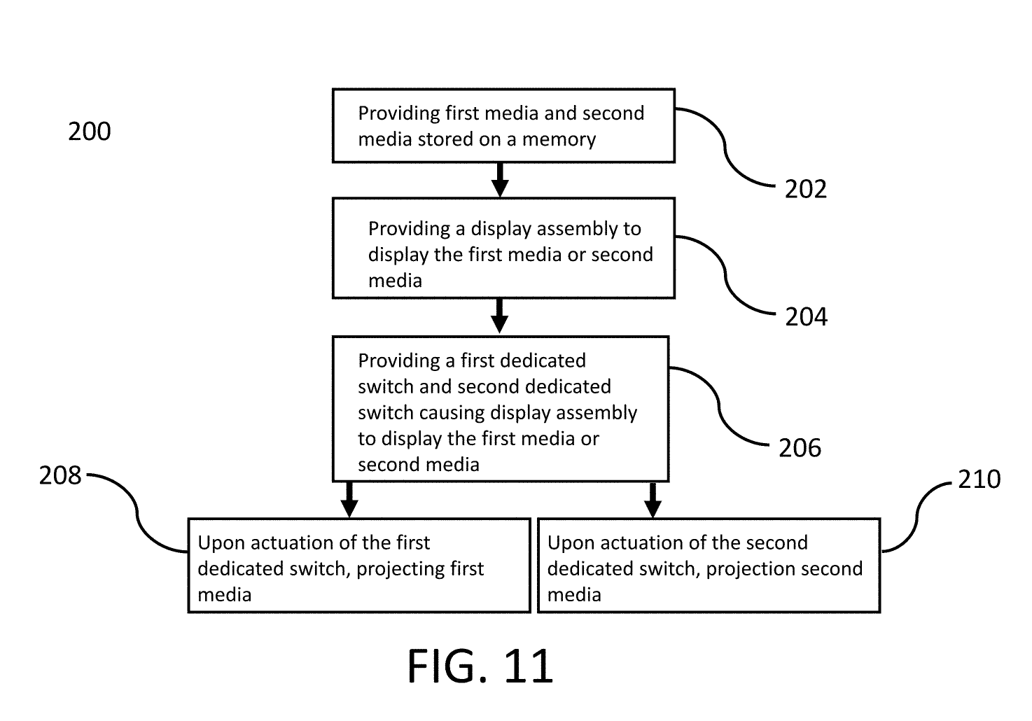

FIG. 11 shows a flow diagram of an exemplary method 200. As shown in FIG. 11, method 200 can include step 202 of providing a first media and second media stored on a memory. A display assembly can be provided in step 204, and first and second dedicated switches can be provided in step 206. In steps 208 and 210, the first and/or second media can be projected upon actuation of the first and/or the second dedicated switch. According to certain exemplary embodiments, method 200 can be performed using, for example, exemplary projector 101, as described in more detail herein.

Optionally, projector 101 can include a mechanism to change an orientation of the media being projected. For example, the mechanism can include a mechanical dial that can enable rotation of various components of projector 101 so that the media being projected is rotated (e.g., 90 degrees, 180 degrees, etc.). Alternatively, projector 101 can include switch 114 to change the orientation of the projected media. According to one exemplary embodiment, this can be accomplished by storing two versions of each media in the memory of PCB 112 (e.g., a landscape version and a portrait version) and changing between the two different versions (e.g., the landscape version and the portrait version) when the orientation button is depressed. Alternatively, switch 114 can electronically rotate the orientation of the projected media. Power switch 114 may include a three-way switch (e.g., rocker switch, sequentially activated switch controlled by an integrated circuit, mechanical switch, mechanical dial, etc.) including a first setting to operate display 106 to present media in a landscape configuration and second setting to operate display 106 to present media in a portrait configuration. Switch 114 may also include a third setting where projector 101 is in an OFF condition. Switch 114 may be any type of switch, such has a push-button, toggle switch, mechanical dial, etc., that can achieve the desired functionality. In one embodiment where power switch 114 is a mechanical dial, the mechanical dial may include a first setting to operate display 106 to present media in a landscape configuration and a second setting to operate display 106 to present media in a portrait configuration. The mechanical dial may be configured to physically rotate one or more components orient the media in landscape configuration and/or portrait configuration. For example, the mechanical dial can be configured to physically rotate one or more components of display assembly 109. Accordingly, the mechanical dial can be configured to rotate display 106, or the entirety of display assembly 109. Switch 114 may also include a third setting where projector 101 is in an OFF condition.

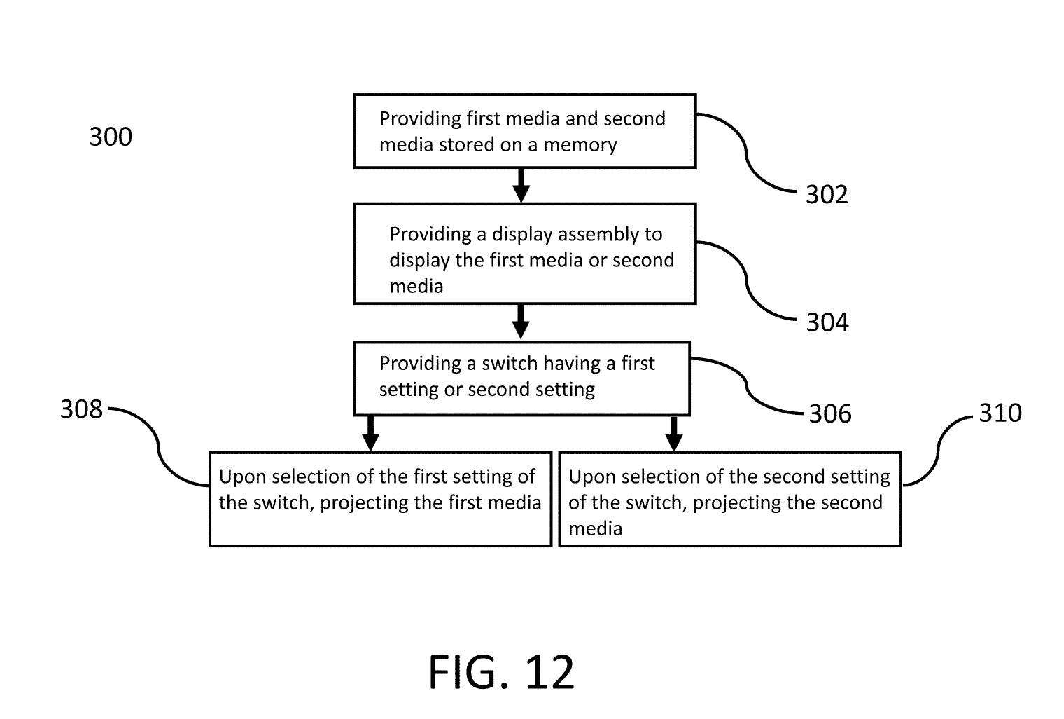

FIG. 12 shows a flow diagram of an exemplary method 300. As shown in FIG. 12, method 300 can include step 302 of providing a first media and second media stored on a memory. A display assembly can be provided in step 304, and a switch having a first setting and second setting can be provided in step 306. In steps 308 and 310, the first and/or second media can be projected upon selection of the first and/or the second setting of the switch. According to certain exemplary embodiments, method 300 can be performed using, for example, exemplary projector 101, as described in more detail herein.

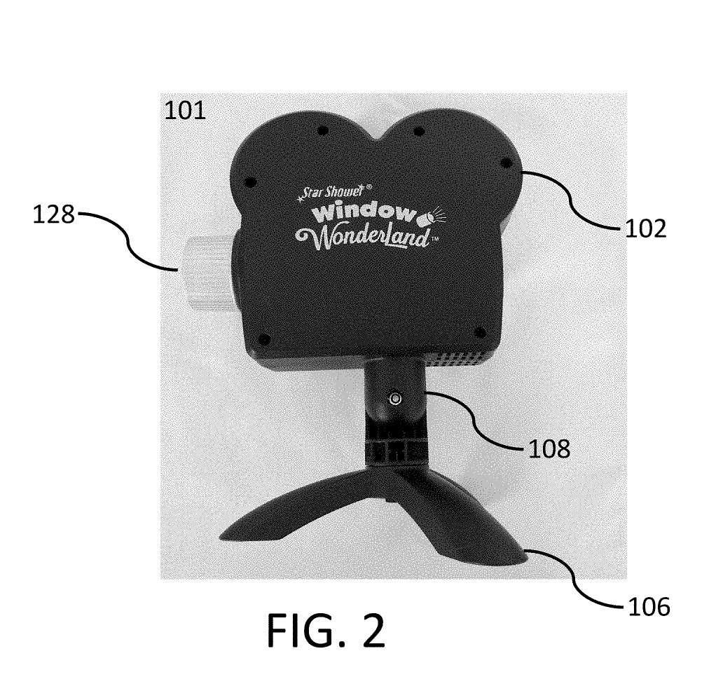

According to exemplary embodiments of the present invention, projector 101 can include a mounting mechanism. Although FIGS. 1 and 2 show the mounting mechanism being stand 127, mounting mechanism may be a platform, a ground stake, a tripod, a clamp, a wall mount, etc. that can allow positioning of projector 101 in a desired location. In one embodiment of the present invention, projector 101 may include adjustment mechanism 108. Adjustment mechanism 108 may be coupled to housing 102 and further coupled to stand 127. Adjustment mechanism 108 may be configured to allow projector 101 to be adjusted and oriented at various angles relative to stand 127 so that the media can be projected at various inclined angles. Alternatively, projector 101 can include threads and/or a screw to receive a standard mounting mechanism such as a standard tripod so that users can use devices that they may already have. In another embodiment of the present invention, the mounting mechanism of the projector 101 may be removable.

In one embodiment of the present invention, projector 101 may be configured to be used outdoors. Projector 101 being configured for outdoor use can facilitate projecting decorative images, shapes, patterns, scenes, and/or videos/video clips on an exterior surface of a structure or building such as a home. According to certain exemplary embodiments, projector 101 can include a short throw projector to cover a wider area while used outdoors.

According to one embodiment, housing 102 may be substantially weather-proofed to enable projector 101 to withstand the elements. For example, housing 102 of projector 101 can include seals and weather proofed elements to prevent moisture, wind, dirt, dust, rain, snow, etc. from entering housing 102. Additional weather-proofing elements may be incorporated along buttons, seams and joints that may be more susceptible to infiltration of weather. Further, projector 101 may include a heating element to ensure operation during in cold weather climates. The heating element may allow for projector 101 to be used in cold or freezing temperatures.

According to another embodiment of the present invention, projector 101 may include various sensors. For example, projector 101 may include a light sensor. The light sensor may be used to control projector 101 depending on the detected level of ambient light. For example, the light sensor may automatically turn projector 101 OFF during the day when the level of ambient light is high and may automatically turn projector 101 ON at night when the detected level of ambient light is low. In another embodiment of the present invention, projector 101 may include a temperature sensor. The temperature sensor may control operation of the heating element and/or projector 101 depending on the sensed ambient temperature. For example, the temperature sensor may automatically turn projector 101 ON or OFF during the periods of extreme cold or hot, as detected by the temperature sensor, to protect the components of projector 101. In yet another embodiment of the present invention, projector 101 may include a fan. The fan may be disposed within projector 101 and can be used to control the temperature and/or the moisture within housing 102.

In yet another embodiment of the present invention, projector 101 may include a timer. The timer may turn projector 101 ON or OFF based on the time of day or based on certain durations of operation. For example, the timer can operate projector 101 at defined times during the evening/night (e.g., 7-9 PM, 8-10 PM, etc.). Alternatively, the timer can allow projector 101 to operate for a specific duration and turn off after the duration has expired. For example, the timer can allow projector 101 to be on for an hour, two hours, 30 minutes, etc. and automatically turn off after the selected duration.

According to another embodiment of the present invention, projector 101 may include a speaker. The speaker may be located anywhere in projector 101. For example, projector 101 may include a speaker located on the bottom of housing 102 or coupled to the bottom of housing 102. The speaker may be used to play any audio media. In yet another embodiment of the present invention, projector 101 may include a recording device. The recording device of projector 101 may allow the user to record various sounds or media. For example, the recording device of projector 101 may allow a user to record a sound and the speaker may allow projector 101 to playback the recorded sound. Projector 101 can also employ Bluetooth technology to be paired with a device, such as a smartphone or computer, to enable playing of media and sounds (e.g., streamed content and stored content) from the paired device.

Projector 101 can also include a wireless remote control to enable wireless operation of projector 101. For example, projector 101 can include a wireless transmitter/receiver that can allow wireless communication with a wireless device. For example, the wireless transmitter/receiver can employ radio frequency (“RF”), Bluetooth, and/or Wi-Fi technology to facilitate wireless communication between projector 101 and the remote control. According to certain embodiments, projector 101 can be wirelessly operated via remote control. For example, the remote control can control powering projector 101 ON and/or OFF, setting the orientation, selecting the media to be played, setting a timer, setting the sensors, etc. Further the remote control can indicate and display the current operating status of projector 101 (e.g., whether or not the projector is ON or OFF and/or the mode of operation). According to certain embodiments, the remote control can be implemented via an app on a mobile device such as a smartphone or tablet, or via a web-based application on a computer.

The embodiments and examples shown above are illustrative, and many variations can be introduced to them without departing from the spirit of the disclosure. For example, elements and/or features of different illustrative and exemplary embodiments herein may be combined with each other and/or substituted with each other within the scope of the disclosure. For a better understanding of the disclosure, reference should be had to any accompanying drawings and descriptive matter in which there is illustrated exemplary embodiments of the present invention.

1. A window projector comprising:
a memory including a first media and a second media stored thereon;
a display assembly configured to display at least one of the first media and the second media, the first media associated with a first characteristic and the second media associated with a second characteristic; and
a first dedicated switch dedicated for displaying the first media and a second dedicated switch dedicated for displaying the second media, the first dedicated switch being configured such that an actuation of the first dedicated switch causes the display assembly to display the first media from the memory and the second dedicated switch being configured such that an actuation of the second dedicated switch causes the display assembly to display the second media from the memory.

2. The window projector of claim 1, wherein the first characteristic and the second characteristic are different.

3. The window projector of claim 1, wherein the first and second characteristics each includes a holiday.

4. The window projector of claim 1, wherein the display assembly includes at least one optical element.

5. The window projector of claim 1, wherein the first media includes a plurality of media, and successive actuations of the first dedicated switch cycles through the plurality of media.

6. The window projector of claim 1, wherein the second media includes a plurality of media, and successive actuations of the second dedicated switch cycles through the plurality of media.

7. The window projector of claim 1, wherein the first media includes a landscape media version and a portrait media version.

8. The window projector of claim 7, further comprising at least one dedicated orientation switch to change an orientation of the first media, the dedicated orientation switch configured to provide selective orientation control between the landscape media version and the portrait media version of the first media.

9. A window projector comprising:
a memory including a first media and a second media stored thereon, the first media including a first content configured to be displayed in a landscape orientation and the second media including the first content configured to be displayed in a portrait orientation;
a display assembly configured to display at least one of the first media and the second media; and
a switch including a first setting and second setting, the first setting corresponding to the projector projecting the first media and the second setting corresponding to the projector projecting the second media.

10. The window projector of claim 9, further comprising a first dedicated switch dedicated to displaying the first content, the first dedicated switch being configured such that an actuation of the first dedicated switch causes the display assembly to display the first content from the memory.

11. The window projector of claim 10, wherein the memory includes a third media and a fourth media stored thereon.

12. The window projector of claim 11, wherein the third media includes a second content configured to be displayed in a landscape orientation and the fourth media including the second content configured to be displayed in a portrait orientation.

13. The window projector of claim 12, further comprising a second dedicated switch dedicated to displaying the second content, the second dedicated switch being configured such that an actuation of the second dedicated switch causes the display assembly to display the second content from the memory.

14. The window projector of claim 12, wherein each of the first and second content includes an associated characteristic.

15. The window projector of claim 14, wherein the characteristic includes a holiday.

16. The window projector of claim 9, wherein the switch includes a third setting, the third setting corresponding to the projector being in an OFF condition.

17. The window projector of claim 9, wherein the switch includes a three-way rocker switch.

18. A method of projecting content comprising:
providing a memory including a first media and a second media stored thereon;
providing a display assembly configured to display at least one of the first media and the second media, the first media associated with a first characteristic and the second media associated with a second characteristic;
providing a first dedicated switch dedicated for displaying the first media and a second dedicated switch dedicated for displaying the second media, the first dedicated switch being configured such that an actuation of the first dedicated switch causes the display assembly to display the first media from the memory and the second dedicated switch being configured such that an actuation of the second dedicated switch causes the display assembly to display the second media from the memory; and
projecting the first media upon actuation of the first dedicated switch.

19. The method of claim 18, further comprising projecting the second media upon actuation of the second dedicated switch.

20. A method of projecting content in different orientations, comprising:
providing a memory including a first media and a second media stored thereon, the first media including a first content configured to be displayed in a landscape orientation and the second media including the first content configured to be displayed in a portrait orientation;
providing a display assembly configured to display at least one of the first media and the second media;
providing a switch including a first setting and second setting, the first setting corresponding to the projector projecting the first media and the second setting corresponding to the projector projecting the second media;
projecting at least one of the first media and the second media upon actuation of the switch.
